(19) United States
(12) Patent Application Publication
(10) Pub. No.: US 2017/0139173 A1
(43) Pub. Date: May 18, 2017

(54) Lens Module

(71) Applicants: Chuandong Wei, Shenzhen (CN); Jie Ma, Shenzhen (CN); Junjie Yan, Shenzhen (CN); Yuchan Gao, Shenzhen (CN)

(72) Inventors: Chuandong Wei, Shenzhen (CN); Jie Ma, Shenzhen (CN); Junjie Yan, Shenzhen (CN); Yuchan Gao, Shenzhen (CN)

(73) Assignee: AAC Technologies Pte. Ltd., Singapore city (SG)

(21) Appl. No.: 15/082,406

(22) Filed: Mar. 28, 2016

(30) Foreign Application Priority Data
Nov. 17, 2015 (CN) 201520917181.4

(51) Int. Cl. G02B 7/02; G02B 13/00; G02B 7/00

(52) U.S. Cl. CPC G02B 7/026; G02B 7/021; G02B 7/025; G02B 7/003; G02B 13/001

(57) ABSTRACT

The present disclosure discloses a lens module. The lens module includes a lens barrel and a lens group. The lens group is installed inside the lens barrel. The lens barrel includes a first barrel wall extended horizontally and a second barrel wall bended and extended from the first barrel wall. The lens module includes also a stop installed inside the lens barrel. The stop is fixed on the first barrel wall. The stop and the lens group are lined up in turn from object side to image side. As the length of the lens barrel is reduced due to the usage of stop, when shaping of lens barrel is being done, the production difficulty of shaping is decreased and the yield of qualified lens barrel is increased.

### FIELD OF THE DISCLOSURE

The present disclosure generally relates to the technical field of optical imaging, more particular to a lens module used in camera, video camera, mobile phone, tablet, notebook PC and other electronic devices.

### BACKGROUND

As the photographic technology and the electronic products with photographic function are developed in recent years, optical camera lens module is used widely in all kinds of products. In order to follow the current trend that the size of electronic products becomes smaller and smaller, the lens module shall also be miniaturized.

In the existing technology, the lens module comprises a lens barrel, lenses located in the lens barrel, and a stop clamped between lenses. The lens barrel comprises a first barrel wall extended horizontally and a second barrel wall extended from the first barrel wall. A light hole is created on the first barrel wall for the lens. However, the light hole on the first barrel wall requires the barrel wall with a certain thickness, therefore, the wall thickness of the barrel wall is increased. The height and weight of entire lens module is increased. It will be more difficult to produce lens barrel.

For this reason, it is necessary to provide a novel lens module to overcome the shortcomings above.

### BRIEF DESCRIPTION OF THE DRAWINGS

Many aspects of the embodiment can be better understood with reference to the following drawings. The components in the drawing are not necessarily drawn to scale, the emphasis instead being placed upon clearly illustrating the principles of the present disclosure. Moreover, in the drawings, like reference numerals designate corresponding parts throughout the several views.

FIG. 1 is a schematic diagram of a lens module in one embodiment of the present disclosure.

### DETAILED DESCRIPTION

The present disclosure will be described in detail below with reference to the attached drawings and an exemplary embodiment thereof.

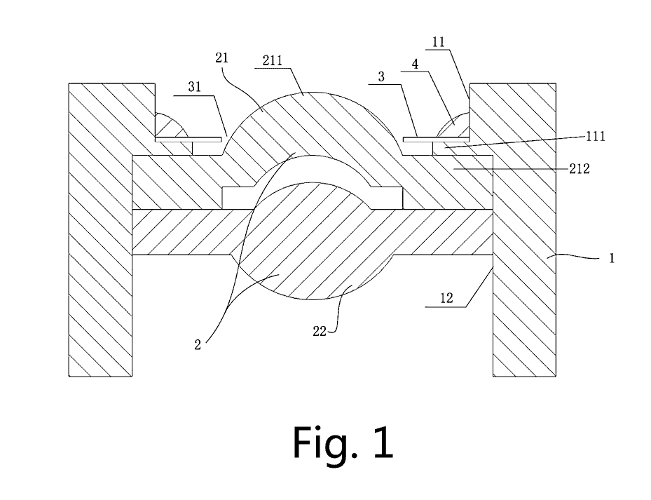

FIG. 1 shows a lens module in one embodiment of the present disclosure. The lens module comprises a lens barrel 1 and a lens group 2. The lens group 2 is installed inside the lens barrel 1. The lens barrel 1 comprises a first barrel wall 11 extended horizontally and a second barrel wall 12 extended from the first barrel wall 11. The lens module comprises also a stop 3 installed inside the lens barrel. The stop 3 is fixed on the first barrel wall 11. The stop 3 and the lens group 2 are lined up in turn from object side to image side. The stop 3 is a hollow ring and creates a light hole 31 of the lens module. The axis of the lens group 2 and the axis of the light hole 31 are aligned in one line.

The object side refers to the side of the lens barrel closer to the object. The image side refers to the opposite side of the object side. It can be seen in FIG. 1 that the first barrel wall 11 is closer to object side. A length of the first barrel wall 11 along the lens barrel center is greater than a length of the second barrel wall 12.

In this embodiment, the lens group 2 is provided with a first lens 21. The first lens 21 includes a first optical part 211 and a first bearing part 212 surrounded the first optical part 211. A normal projection of the first optical part 211 along the optical axis is located at least partially on the stop 3.

The lens barrel is provided with a lug 111 extended from an inner surface of the first barrel wall 11 to the axis of the lens barrel 1. The lug 111 is clamped between the stop 3 and the first bearing part 212 of the first lens 21. A receiving groove is created by the lug 111 and the inner surface of the first barrel wall 11. The stop is located partially in the receiving groove. This structure is featured that the stop can be assembled easily. The stop is installed and fixed in the receiving groove when assembling the lens. In this embodiment, the stop 3 is fixed by glue 4 on the first barrel wall 21.

The lens group is provided also with a second lens 22 which is opposite to the first lens 21 and located under the first lens 21. The first bearing part 212 of the first lens 21 is clamped between the first barrel wall 11 and the second lens 22. Certainly, in other embodiments, lens group can consist of two or more lenses.

Firstly, in the lens module disclosed above, the stop is fixed on the first barrel wall. The stop installed creates a block structure to install the lens group. The block structure replaces the convex part molded on existing lens barrel. As the thickness of the stop is much smaller than the width of the convex part along the axial direction of the lens barrel, the length of the lens barrel is reduced greatly. Secondly, as the thickness of the stop is much smaller than the width of the convex part along the axial direction of the lens barrel, the reflection of the light on the inner surface of the stop is reduced significantly when the light passes though the light hole in the lens group. The glare of imaging is reduced and the imaging quality of the lens module is improved. In addition, when the lens barrel top has a certain thickness, as the length of the lens barrel is reduced due to the stop, the production difficulty of the lens barrel is reduced and the yield of qualified lens barrel is increased.

It is to be understood, however, that even though numerous characteristics and advantages of the present embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A lens module comprising:
a lens barrel comprising a first barrel wall extended horizontally and a second barrel wall extended from the first barrel wall;
a lens group installed inside the lens barrel, and comprising a stop installed inside the lens barrel; wherein
the stop is fixed on the first barrel wall, the stop and the lens group are lined up in turn from an object side of the lens module to an image side of the lens module.

2. The lens module according to claim 1, wherein the stop is a hollow ring.

3. The lens module according to claim 2, wherein the lens group is provided with a first lens including a first optical part and a first bearing part surrounded the first optical part, a normal projection of the first optical part along an optical axis of the lens module is located at least partially on the stop.

4. The lens module according to claim 3, wherein the lens barrel is provided with a lug extended from an inner surface of the first barrel wall along the optical axis, the lug is clamped between the stop and the first bearing part, and a receiving groove is formed by the lug and the inner surface of the first barrel wall, the stop is located partially in the receiving groove.

5. The lens module according to claim 4, wherein the lens group further includes a second lens opposite to the first lens and located under the first lens.

6. The lens module according to claim 5, wherein the first bearing part of the first lens locates between the first barrel wall and the second lens.

7. The lens module according to claim 1, wherein the stop is fixed by glue on the first barrel wall.

8. The lens module according to claim 1, wherein the stop forms a light hole, the optical axis of the lens group and an axis of the light hole are aligned with each other.
